(19) United States
(12) Patent Application Publication
(10) Pub. No.: US 2008/0218871 A1
(43) Pub. Date: Sep. 11, 2008

(54) MIRROR ASSEMBLY

(75) Inventors: Daniel R. Todd, Sheboygan, WI (US); Allen A. Bukosky, Sheboygan, WI (US)

Correspondence Address: WELLS ST. JOHN P.S., 601 W. FIRST AVENUE, SUITE 1300, SPOKANE, WA, 99201, US

(73) Assignee: K.W. Muth Company, Inc.

(21) Appl. No.: 11/714,461

(22) Filed: Mar. 5, 2007

(51) Int. Cl. G02B 27/14

(52) U.S. Cl. 359/634; 359/629

(57) ABSTRACT

A mirror assembly is described and which includes a semitransparent mirror, a circuit substrate positioned adjacent to the semitransparent mirror, and a first heater borne by the circuit substrate, and which is coupled with the source of electricity, and which is disposed in juxtaposed heat transmitting relation relative to the semitransparent mirror.

### TECHNICAL FIELD

The present invention relates to a mirror assembly and more specifically to a mirror assembly having particular utility when coupled with the controls of an overland vehicle.

### BACKGROUND OF THE INVENTION

The beneficial effects of employing auxiliary signaling assemblies have been disclosed in various patents such as U.S. Pat. No. 6,005,724 and more recently U.S. Pat. No. 7,008,091 the teachings of which are incorporated by reference herein. Yet further, a multiplicity of other signaling assemblies having various semitransparent mirrors including dichroic and electrochromic type mirrors are disclosed in the prior art. In addition to providing an auxiliary signaling device, such prior art assemblies have also included auxiliary lighting which has been typically remotely actuated in order to provide additional advantageous features like providing an exterior vehicle security light which aids and assists operators and passengers during the evening hours. Examples of such assemblies are shown in U.S. Pat. Nos. 5,371,659 and 5,497,305 to name but a few.

While these various prior art assemblies have operated with a great deal of success, and are now found on many vehicle platforms, there have remained shortcomings with respect to the individual designs which have detracted, to some degree, from their usefulness. As will be understood by a review of the many prior art references, various inventors and manufacturers have recognized the advantages of utilizing exterior mirrors on an overland vehicle to position various light sources which may be utilized to warn an operator of hazards, or to further, provide auxiliary lighting for the overland vehicle. While numerous advantages are provided by the placement of various sensors, warning icons and auxiliary lighting in both interior and exterior overland vehicle mirrors, there continues to be an associated problem regarding space availability within the mirror housings, themselves. As should be understood, ever evolving vehicle platform designs have continued to emphasize reduced outside mirror housing dimensions so as to be consistent with the smaller, more compact vehicle platforms which are being developed and commercially introduced.

These reduced dimensioned mirror housings have created a myriad of problems. For example, one of the chief problems has been that the addition of the various auxiliary lighting assemblies, icons and the like which have been employed with the semitransparent mirror which are used in these assemblies have occupied an ever increasing amount of surface area of the semitransparent mirror associated with same. It has long been recognized that to be effective, the semitransparent mirrors associated with these signaling assemblies must remain substantially clear so as to allow unimpeded viewing by the operator of the overland vehicle during operation during all ambient operating conditions.

Therefore, a signal mirror which has improved performance under various environmental conditions is the subject matter of the present invention.

### SUMMARY OF THE INVENTION

Therefore, one aspect of the present invention relates to a mirror assembly which includes a semitransparent mirror which simultaneously passes and reflects visibly discernible electromagnetic radiation; a circuit substrate positioned in juxtaposed relation relative to the semitransparent mirror, and which is coupled with a source of electricity; a plurality of electromagnetic radiation emitters borne by the circuit substrate and which are electrically coupled with the source of electricity through the circuit substrate; and a first heater borne by the circuit substrate, and which is coupled with the source of electricity by the circuit substrate, and which is further disposed in juxtaposed heat transmitting relation relative to the semitransparent mirror, and wherein the heater, when energized, transmits heat energy to the region of the semitransparent mirror which is immediately adjacent thereto.

Still further, another aspect of the present invention relates to a mirror assembly which includes a semitransparent mirror which has a rearwardly facing surface, and which defines, at least in part, a discreet region which has a surface area, and wherein the discreet region simultaneously passes and reflects visibly discernible electromagnetic radiation; an opaque circuit substrate having a surface area which is greater than about 50% of the surface area of the discreet region which passes and reflects visibly discernible electromagnetic radiation, and which is positioned in juxtaposed, partial covering relation relative to the discreet region, and wherein the opaque circuit substrate defines a plurality of spaced apertures which facilitate the passage of visibly discernible electromagnetic therethrough, and wherein the opaque circuit substrate is coupled with a source of electricity; a plurality of electromagnetic radiation emitters which are borne by the opaque circuit substrate, and which are individually positioned adjacent to each of the plurality of apertures which are formed in the circuit substrate, and wherein the respective electromagnetic radiation emitters, when energized by the source of electricity emit visibly discernible electromagnetic radiation which is reflected, at least in part, through the respective plurality of apertures and which further passes through the discreet region of the semitransparent mirror; a reflector disposed in reflecting relation relative to the respective electromagnetic radiation emitters, and which reflects the visibly discernible electromagnetic radiation, at least in part, through the individual apertures; and a first heater borne by the opaque circuit substrate and electrically coupled with the source of electricity, and wherein the heater is disposed in juxtaposed heat transferring relation relative to the semitransparent mirror, and wherein the heater, when energized by the source of electricity, imparts heat energy to greater than about 50% of the surface area of the discreet region which is covered by the opaque circuit substrate.

These and other aspects of the present invention will be described in greater detail hereinafter.

### BRIEF DESCRIPTION OF THE DRAWINGS

Preferred embodiments of the invention are described below with reference to the following accompanying drawings.

FIG. 1 is a greatly simplified, perspective, exploded view of the mirror assembly of the present invention.

FIG. 2 is a plan view of the rearward facing surface of a circuit substrate employed in the mirror assembly of the present invention.

FIG. 3 is a plan view of a first form of the forward facing surface of a circuit substrate employed in the mirror assembly of the present invention.

FIG. 4 is a plan view of a second form of the rearward facing surface of a second form of the circuit substrate utilized in the mirror assembly of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

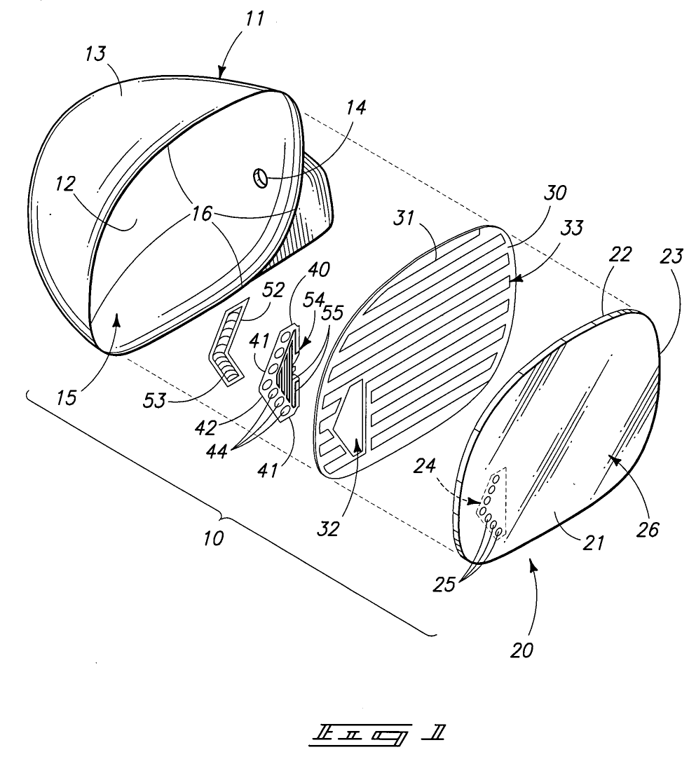

Referring more particularly to the drawings, the mirror assembly of the present invention is generally indicated by the numeral 10 in FIG. 1. As seen in that view, the present invention is enclosed within or otherwise cooperates with a mirror housing 11, and which is mounted on the exterior surface of an overland vehicle (not shown). The mirror housing or enclosure 11 is defined by a rear wall 12 and further has a sidewall 13 which extends outwardly relative thereto. The sidewall 13 further defines a first aperture 14 which permits a wire harness (not shown) to extend therethrough and which is coupled to a source of electricity which is generated by the overland vehicle during operation. As will be recognized, the rear wall 12, and sidewall 13, defines an internal cavity 15 which is operable to receive, and enclose the present invention 10 and other devices typically associated with such an assembly. These additional assemblies may include, for example, a moveable bezel (not shown) which allows the operator of an overland vehicle to selectively orient a semitransparent mirror (as will be described below) so that the operator may see regions which are rearwardly and laterally oriented relative to the overland vehicle (not shown). In addition to the foregoing, it will be recognized that the sidewall 13 defines a second aperture 16 and which has a cross-sectional dimension which is greater than a semitransparent mirror 20 which is moveably mounted within same and which substantially occludes this second aperture 16.

Still referring to FIG. 1, the present invention 10, as noted above, includes a semitransparent mirror which is generally indicated by the numeral 20, and which has a front or exterior facing surface 21, and an opposite or rearwardly facing surface 22. The semitransparent mirror 20 is further defined by a peripheral edge 23 which substantially corresponds in shape and is slightly smaller, in size, relative to the second aperture 16 which is defined by the sidewall 13 of the mirror housing 11. As should be understood from the earlier discussion of the prior art, the semitransparent mirror 20 may take on several forms. Typically, the semitransparent mirror will have a highly reflective mirror coating (not shown) which is formed on the rearward facing surface 22 thereof. In an alternative form, the mirror coating may be applied to the forward facing surface 21. In still another form, the semitransparent mirror may comprise an electrochromic mirror. The highly reflective mirror coating may comprise any number of different highly reflective, or mirror like coatings, or substances, such as chromium and the like, and which may be applied or formed in a manner which provides a commercially acceptable reflective surface. For automotive applications the resulting reflectance of the semitransparent mirror 20 should be, on average, greater than about 35%. Other amounts of reflectivity may be acceptable for other commercial applications. As seen by reference to FIG. 1, the semitransparent mirror 20 has a first or primary region 24, and through which a visibly discernable electromagnetic radiation signal may pass. In this regard, a plurality of translucent or transparent regions 25 may be formed in the primary region as by, for example, removal of some, or all of the highly reflective mirror coating which has been placed on the rearward facing surface 22 so as to facilitate the passing of the electromagnetic radiation therethrough. Additionally, the semitransparent mirror 20 has a secondary region 26. This secondary region is operable to reflect visibly discernable electromagnetic radiation and is otherwise considered nominally opaque. The combined, average reflectivity of the overall surface area of the semitransparent mirror 20, including both the primary and secondary regions 24 and 26 is normally greater than 35% when employed for automotive applications. In other industrial applications, the average reflectance may be lower or higher depending upon the desired end use. As seen in the drawings, the secondary region 26 is substantially continuous and reflects, for automotive applications, greater than about 35% of visible electromagnetic radiation, and further passes less than about 10% of visibly discernable electromagnetic radiation. The first or primary region 24, and more specifically the translucent or transparent region 25 thereof, on the other hand, passes greater than about 50% of visible electromagnetic radiation, and further reflects on average less than about 40% of the same visible electromagnetic radiation. The ranges noted above have been found suitable for automotive applications, however, it will be recognized that other broadened or narrowed ranges may be useful for other applications.

As best understood by a study of FIG. 1, a heater substrate, film or coating and which is generally indicated by the numeral 30 is juxtaposed or otherwise applied thereagainst the rearward facing surface 22 of the semitransparent mirror 20. The heater substrate, film or coating is substantially non-conductive and may, in one form of the invention, be substantially translucent or transparent so that visibly discernable electromagnetic radiation may pass therethrough. Still further, a plurality of electrically conductive pathways which are generally indicated by the numeral 31, are fabricated in a given pattern on the heater substrate film or coating 30 so as to provide a means by which electricity which passes along same may impart heat energy to the adjacent rearwardly facing surface 22 of the semitransparent mirror 20. This heat energy is utilized to heat the semitransparent mirror 20 in a fashion so as to render the semitransparent mirror substantially snow, or frost-free during low ambient temperature, or weather conditions. The heater substrate, film or coating 30 has a primary region which is generally indicated by the numeral 32. In one form of the invention, the primary region 32 which has no electrically conductive pathways 31, may be continuous, and transparent so that visible electromagnetic radiation may pass therethrough. In another possible form of the invention as seen in FIG. 1, the primary region 32 may be defined by an aperture having a given shape which is substantially similar to the primary region 24 as defined in the semitransparent mirror 20. Still further, the heater substrate, film or coating 30 has a secondary region 33 which supports and otherwise orients the plurality of electrically conductive pathways 31 so that they may individually impart heat energy to the semitransparent mirror 20. As seen in FIG. 1, the primary region 32 of the heater substrate film or coating is substantially coaxially aligned relative to the primary region 24 as defined in the semitransparent mirror 20 when the mirror assembly 10 is assembled.

Referring now to FIGS. 1-4 it will be seen that the present invention 10 includes a circuit substrate which is generally indicated by the numeral 40. The circuit substrate is substantially non-conductive and has a forward facing surface 41 which is disposed in juxtaposed rested relation relative to the rearwardly facing surface 22 of the semitransparent mirror 20. The circuit substrate further has an opposite, rearwardly facing surface 42. Still further, the circuit substrate is defined by a peripheral edge 43. As should be understood, the overall shape of the circuit substrate 40 is very closely similar to the shape of the primary region 24 as defined in the semitransparent mirror 20 and which is operable to pass, at least in part, visibly discernable electromagnetic radiation through the plurality of translucent or transparent areas or regions 25 which are formed therein. In another possible form of the invention, the circuit substrate 40 has a surface area greater than the primary region 24. As illustrated in FIGS. 2-4, the circuit substrate has a plurality of apertures 44 formed therein and which are located in predetermined spaced relation one relative to the others, and which are further disposed in a given geometric pattern. The plurality of apertures extend between the forward and rearward facing surfaces 41 and 42, and further permit visibly discernable electromagnetic radiation, which is produced by a plurality of energized LEDs 45 to pass therethrough. As illustrated in the drawings, the plurality of LEDs 45 are individually positioned on the rearwardly facing surface 42, and adjacent to each of the respective apertures 44 which are formed in the circuit substrate 40. As best seen by reference to FIG. 2, a first electrically conductive pathway 50 is formed on the rearwardly facing surface 42 and which electrically couples the plurality of LEDs 45 to an appropriate source of electricity so that they may be selectively energized in a manner which is well known in the art. Additionally, it will be seen by a study of FIG. 2, that a conventional electrical coupler 51 is mounted on the rearward facing surface 42 and is operable to interface with an appropriate wire harness (not shown) so that electrical power from the overland vehicle may be selectively supplied to the plurality of LEDs as will be discussed in greater detail, below.

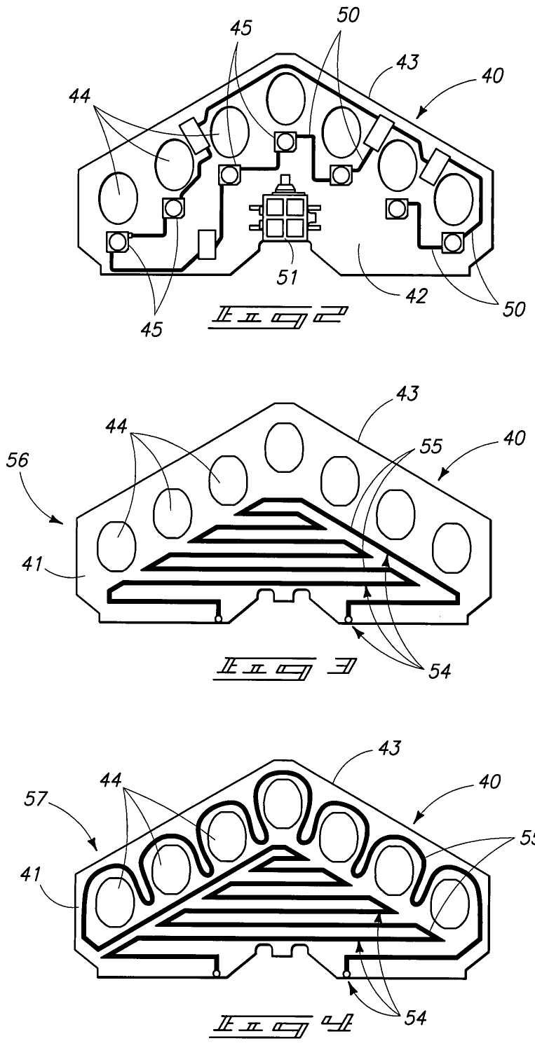

Positioned in covering, eccentric reflecting relation relative to the plurality of LEDs 45 is a reflecting element or reflector 52 which is well known in the art. The reflecting element 52 defines a single internal cavity 53 or multiple internal cavities within which the plurality of LEDs are positioned. When energized, the plurality of LEDs 45 emit visibly discernable electromagnetic radiation which is eccentrically reflected by the reflecting element 52 so as to pass out through the plurality of apertures 45 and then be passed by the semitransparent mirror 21 by means of the plurality of translucent or transparent regions 25 which are formed therein. Referring now to FIGS. 3 and 4 where two possible forms of the invention are shown, it should be understood that a first heater 54, which is defined by a second electrically conductive pathway 55 is borne by the forward facing surface 41 of the circuit substrate 40, and which is further coupled with a source of electricity by the circuit substrate. The first heater 54 which is defined by the second, electrically conductive pathway 55, is disposed in juxtaposed heat transmitting relation relative to the semitransparent mirror 20, and wherein the heater 54, when energized, transmits heat energy to the primary region 24 of the semitransparent mirror 20 in order to maintain the temperature of the primary region at an acceptable level so as to inhibit the development of frost or rid the region of snow or ice accumulation on the surface of same during low ambient temperature conditions. As seen in FIG. 3, a first form 56 of the first heater 54 is illustrated. Further, a second form of the heater 57 is shown in FIG. 4.

Therefore, one aspect of the present invention relates to a mirror assembly 10 which includes a semitransparent mirror 20 which simultaneously passes, and reflects visibly discernible electromagnetic radiation; and a circuit substrate 40 is positioned in juxtaposed relation relative to the semitransparent mirror 20, and which is coupled with a source of electricity (not shown). The present invention includes a plurality of electromagnetic radiation emitters 45 which are borne by the circuit substrate 40, and which are electrically coupled with the source of electricity through the circuit substrate. Still further, the invention includes a first heater 54 which is borne by the circuit substrate 40, and which is coupled with the source of electricity by the circuit substrate 40. The first heater 54 is further disposed in juxtaposed heat transmitting relation relative to the semitransparent mirror 20, and wherein the heater 54, when energized, transmits heat energy 24 to the primary region 24 of the semitransparent mirror 20 which is immediately adjacent thereto. As seen from a review of the drawings, the semitransparent mirror 20 has a forward 21, and a rearward facing surface 22, and wherein the rearward facing surface 22 of the semitransparent mirror and the circuit substrate 40 each have a surface area. It should be understood that the surface area of the circuit substrate 40 is less than about 50% of the surface area of the rearward facing surface 22 of the semitransparent mirror 20. Still further, the circuit substrate 40 has a forward facing surface 41 and rearward facing surface 42 and wherein the first heater 54 is positioned on the forward facing surface 41 of the circuit substrate 40, and is further juxtaposed relative to the rearward facing surface 22 of the semitransparent mirror 20. Still further, a second heater 30 is borne by the rearward facing surface 22 of the semitransparent mirror 20, and is operable to impart heat energy to the remaining secondary region 26 of the rearward facing surface of the semitransparent mirror 20 which is not immediately adjacent to the circuit substrate 40 when the second heater 30 is energized by a source of electricity. In the present invention, it should be understood that the second heater 30 may be directly electrically coupled with a source of electricity which is produced by the overland vehicle (not shown). Still further, in another possible form of the invention, the second heater 30 may be electrically coupled to the source of electricity provided by the overland vehicle by means of the circuit substrate 40. Still further, it should be appreciated that the first and second heaters 54 and 30, respectively, may be synchronously energized by the circuit substrate 40 or further, in an alternative form may be asynchronously energized by the circuit substrate 40 as appropriate. In the arrangement as seen in the drawings, the plurality of electromagnetic radiation emitters, here illustrated as light emitting diodes 45, are mounted on the rearward facing surface 42 of the circuit substrate 40, and further a plurality of apertures 44 are formed in the circuit substrate 40. As seen in FIG. 2, at least one of the plurality of electromagnetic radiation emitters 45 are mounted adjacent to each of the respective apertures 40. Still further, a reflector 52 is provided and which is disposed in eccentric reflecting relation relative to each of the plurality of electromagnetic radiation emitters 45. As seen in the drawings, the first heater 54 is positioned on greater than about 50% of the forward facing surface 41 of the circuit substrate 40.

Therefore, the mirror assembly 10 of the present invention includes a semitransparent mirror 20 which has rearwardly facing surface 22, and which defines, at least in part, a discreet region 24 which has a surface area, and wherein the discreet region 24 simultaneously passes and reflects visibly discernible electromagnetic radiation. The present invention 10 further includes an opaque circuit substrate 40 having a surface area which is greater than about 50% of the surface area of the discreet region 24, and which passes and reflects visibly discernible electromagnetic radiation. The circuit substrate 40 is positioned in juxtaposed, at least in partial covering relation relative to the discreet region 24. The opaque circuit substrate 40 defines a plurality of spaced apertures 44 which facilitates the passage of visibly discernible electromagnetic radiation therethrough. The opaque circuit substrate 40 is coupled with a source of electricity. In addition to the foregoing, the present invention includes a plurality of electromagnetic radiation emitters 45 which are borne by the opaque circuit substrate 44, and which are individually positioned adjacent to each of the plurality of apertures 44 which are formed in the circuit substrate 40. Moreover, the respective electromagnetic radiation emitters 45, when energized by a source of electricity, emit visibly discernible electromagnetic radiation which is reflected, at least in part, through the respective plurality of apertures 44 and which further passes through the discreet region 24 of the semitransparent mirror 20. As seen in the drawings, a reflector element is disposed in reflecting relation relative to the respective electromagnetic radiation emitters 45, and which reflects the visibly discernible electromagnetic radiation emitted by the emitters, at least in part, through the individual apertures 44. As seen in FIGS. 2-4, a first heater 54 is borne by the opaque circuit substrate 40 and is electrically coupled with the source of electricity. The heater 54 is disposed in juxtaposed heat transferring relation relative to the semitransparent mirror 20, and wherein the heater, when energized by the source of electricity, imparts heat energy to greater than about 50% of the surface area of the discreet region 24 of the semitransparent mirror 20 which is covered by the opaque circuit substrate 40. As earlier described, the semitransparent mirror 20 has a remaining rearwardly region 26 which is positioned adjacent to the discreet region 24. The present invention further includes a second heater 30 which is disposed in heat transferring relation relative to at least a portion of the remaining region 26 and more specifically rearwardly facing surface area thereof. As earlier discussed, the second heater 30, when energized by the source of electricity, imparts heat energy to the portion of the remaining rearwardly facing surface area which is positioned immediately adjacent thereto.

Therefore, it will be seen that the mirror assembly 10 of the present invention provides many advantages over the prior art devices which have been utilized heretofore and assures that the semitransparent mirror 20 which is utilized with same remains free of frost, snow, ice and the like during low ambient temperatures.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A mirror assembly, comprising:
a semitransparent mirror with a forward and rearward facing surface, and which simultaneously passes and reflects visibly discernible electromagnetic radiation;
a circuit substrate with a forward and a rearward facing surface, and which is positioned in juxtaposed relation relative to the semitransparent mirror, and which is coupled with a source of electricity, and wherein the rearward facing surface of the semitransparent mirror and the circuit substrate each have a surface area, and wherein the surface area of the circuit substrate is less than about 50% of the surface area of rearward facing surface of the semitransparent mirror;
a plurality of electromagnetic radiation emitters borne by the circuit substrate and which are electrically coupled with the source of electricity through the circuit substrate;
a first heater positioned on the forward facing surface of the circuit substrate, and which is coupled with the source of electricity by the circuit substrate, and which is further disposed in juxtaposed heat transmitting relation relative to the rearward facing surface of the semitransparent mirror, and wherein the heater, when energized, transmits heat energy to the region of the semitransparent mirror which is immediately adjacent thereto; and
a second heater borne by the rearward facing surface of the semitransparent mirror and which is operable to impart heat energy to the remaining region of the rearward facing surface of the semitransparent mirror which is not immediately adjacent to the circuit substrate.

2. (canceled)

3. A mirror assembly as claimed in claim 1, and wherein the second heater is directly electrically coupled with the source of electricity.

4. A mirror assembly as claimed in claim 1, and wherein the second heater is electrically coupled with the source of electricity by the circuit substrate.

5. A mirror assembly as claimed in claim 4, and wherein the first and second heater are synchronously energized by the circuit substrate.

6. A mirror assembly as claimed in claim 4, and wherein the first and second heaters are asynchronously energized by the circuit substrate.

7. A mirror assembly as claimed in claim 1, and wherein the plurality of electromagnetic radiation emitters are mounted on the rearward facing surface of the circuit substrate, and wherein a plurality of spaced apertures are formed in the circuit substrate, and wherein at least one of the plurality of electromagnetic radiation emitters are mounted adjacent to each of the respective apertures.

8. A mirror assembly as claimed in claim 7, and further comprising:
a reflector disposed in eccentric reflecting relation relative to each of the plurality of electromagnetic radiation emitters.

9. A mirror assembly as claimed in claim 7, and wherein the first heater is positioned on greater than about 50% of the forward facing surface area of the circuit substrate.

10. A mirror assembly, comprising:
a semitransparent mirror which has a rearwardly facing surface, and which defines, at least in part, a discreet region which has a surface area, and wherein the discreet region simultaneously passes and reflects visibly discernible electromagnetic radiation;
an opaque circuit substrate having a surface area which is greater than about 50% of the surface area of the discreet region which passes and reflects visibly discernible electromagnetic radiation, and which is positioned in juxtaposed, partial covering relation relative to the discreet region, and wherein the opaque circuit substrate defines a plurality of spaced apertures which facilitate the passage of visibly discernible electromagnetic radiation therethrough, and wherein the opaque circuit substrate is coupled with a source of electricity;
a plurality of electromagnetic radiation emitters which are borne by the opaque circuit substrate, and which are individually positioned adjacent to each of the plurality of apertures which are formed in the circuit substrate, and wherein the respective electromagnetic radiation emitters, when energized by the source of electricity emit visibly discernible electromagnetic radiation which is reflected, at least in part, through the respective plurality of apertures and which further passes through the discreet region of the semitransparent mirror
a reflector disposed in reflecting relation relative to the respective electromagnetic radiation emitters, and which reflects the visibly discernible electromagnetic radiation, at least in part, through the individual apertures; and
a first heater borne by the opaque circuit substrate and electrically coupled with the source of electricity, and wherein the heater is disposed in juxtaposed heat transferring relation relative to the semitransparent mirror, and wherein the heater, when energized by the source of electricity, imparts heat energy to greater than about 50% of the surface area of the discreet region which is covered by the opaque circuit substrate.

11. A mirror assembly as claimed in claim 10, and wherein the semitransparent mirror has a remaining rearwardly facing surface area which is positioned adjacent to the discreet region, and wherein the mirror assembly further comprises:
a second heater which is disposed in heat transferring relation relative to at least a portion of the remaining rearwardly facing surface area, and wherein the second heater, when energized by the source of electricity, imparts heat energy to the portion of the remaining rearwardly facing surface area which is positioned immediately adjacent thereto.

12. A mirror assembly as claimed in claim 11, and wherein the second heater is electrically coupled to the opaque circuit substrate.

13. A mirror assembly as claimed in claim 11, and wherein each of the first and second heaters are individually electrically coupled with the source of electrical power.

14. A mirror assembly as claimed in claim 10, and wherein the semitransparent mirror is substantially neutrally chromatic.

15. A mirror assembly as claimed in claim 10, and wherein at least a portion of the discreet region of the semitransparent mirror is dichroic.

16. A mirror assembly as claimed in claim 10, and wherein the semitransparent mirror is electrochromic.
